(19) United States
(12) Patent Application Publication
(10) Pub. No.: US 2021/0192923 A1
(43) Pub. Date: Jun. 24, 2021

(54) OPERATING STATE INDICATION DEVICE

(71) Applicant: WERMA Holding GmbH + Co. KG, Rietheim-Weilheim (DE)

(72) Inventors: Christian Hoehler, DE (DE); Daniel Kensy, Tuttlingen (DE)

(21) Appl. No.: 17/131,565

(22) Filed: Dec. 22, 2020

(30) Foreign Application Priority Data
Dec. 23, 2019 (DE) 10 2019 135 683.0

(51) Int. Cl. G08B 21/18; G07C 5/12; G06F 13/10; G06F 21/60; G08B 7/06

(52) U.S. Cl. CPC G08B 21/18; G07C 5/12; G08B 7/06; G06F 21/602; G06F 13/102

(57) ABSTRACT

The invention relates to an operating state indication device for optically and/or acoustically indicating at least one operating state or a plurality of different operating states of a technical apparatus, such as a machine, an installation, a vehicle or the like, having at least one optical and/or acoustic indication and/or warning element, wherein setting and/or adjustment of at least one operating parameter of the indication and/or warning element, such as luminous color, color intensity, luminous image, volume, melody, tone sequence or the like, is provided, wherein at least one input line, which comes from the technical apparatus and is intended to transmit the information relating to at least one operating state, and at least one control line to the indication and/or warning element for controlling the indication of the operating state are provided. The invention is distinguished by the fact that an interface unit for forwarding the information relating to the operating state, which arrives from the technical apparatus, to an external logic unit and/or for receiving a control signal from the external logic unit for directly controlling one or more indication or warning elements is provided.

The invention relates to a device for indicating an operating state according to the precharacterizing clause of claim 1.

Such devices are used in different technical apparatuses, such as machines, installations, vehicles or the like, in order to indicate and possibly warn of an operating state of the technical apparatus via an optical indication or an acoustic indication, for example. Fault-free operation or the standstill of a machine on account of a fault can be indicated, for example. In case of an installation, it is possible to indicate, for example, that passage is enabled or blocked. In the case of a vehicle, it is possible to indicate, for example, when the vehicle is moving, in particular to warn of reversing. These and many other functions can be sensed by an indication device according to the claims.

Such indication devices are often in the form of so-called signal towers with exchangeable modules. Such signal towers are described, for example, in the documents DE 100 58 695 A1, EP 3007 517 A1, EP 2 182 776 A1, EP 2765 562 A1, EP 1 650 721 A1 and EP 1575 011 A1.

Indication devices according to the prior art are generally connected to the respective technical apparatus via a cable connection, via which the information relating to the operating state to be indicated is transmitted. A logic unit inside the indication device converts this information into control of an indication or warning element, with the result that the corresponding indication is effected. For example, an optical warning element can emit light in a color provided for the indication of the operating state to be indicated. An acoustic warning element may also be controlled accordingly, for example. An internal logic unit therefore links one or more input variables, thus resulting in one or more output variables.

In addition, the documents EP 2 209 099 A1 and EP 2 182 494 A1, for example, have disclosed signal towers which can be connected to a data processing unit via a radio module. In particular, a network can also be set up using a plurality of such signal towers. The operating state occurring on a particular technical apparatus at a location cannot only be indicated on the signal tower assigned in situ via such a network, for example, but rather a signal tower arranged remotely therefrom can also make a corresponding indication, by means of control via the network, for example in the vicinity of a supervisor in a factory hall. In order to control such a further signal tower, the logic unit of such a signaling apparatus network uses the same internal logic unit which is provided for direct control and cabling to a technical apparatus. This internal logic unit specifies the possible signals which can be emitted and the events which trigger signals.

In contrast, the object of the invention is to propose an indication device which can be controlled in a more variable manner.

Starting from an indication device according to the precharacterizing clause of claim 1, this object is achieved by means of the characterizing features of said claim.

Advantageous embodiments and developments of the invention are possible by virtue of the features mentioned in the subclaims.

Accordingly, a device according to the invention is distinguished by the fact that an interface unit for forwarding the information relating to the operating state to be indicated, which arrives from the technical apparatus, to an external logic unit and/or for receiving a control signal from the external logic unit for directly controlling one or more indication or warning elements is provided. Such an external logic unit also links one or more input variables, thus resulting in one or more output variables.

Such input variables may be present, for example, as maintenance information, material shortage information, date/time, shift change information, material defect information, energy supply information or the like. Existing or imminent faults, material shortages, planned or preventative maintenance, pending personnel changes, voice output information, text information, hazardous situations, order changes, “everything in order” information, performance problems, deviations from actual values to desired values or the like come into consideration, for example, as output variables in which signals from the external logic unit result in switching of the signal states.

This measure now enables a more variable indication by the device according to the invention since the function of the indication or warning elements can be externally controlled. It is therefore possible, by changing the external control, to change the indication or warning function, for example by changing the coloring of an optical signal, lighting times, light sequences, a light series of different color segments or the like by means of the external logic unit. The same variable control also results for acoustic indications or warning elements, that is to say overall for all types of operation of the indication or warning elements. In particular, the variability is increased in this case by virtue of the fact that the indication or warning function can be changed by simply changing the software or the parameterization in the external logic unit.

The use of an external logic unit also makes it possible to take into account further external information which does not directly come from the respective technical apparatus in order to allow this information to be included in the function of the controlled indication or warning element(s). Such external additional information may be, for example, information relating to the operating state of further technical apparatuses or logistical or further technical information. For example, volumes of orders, quantities, parts lists, productivity, set-up processes or the like can be taken into account in order to control particular indications or warnings in the indication device according to the invention. Sensor information, for example relating to vibrations of a machine, other reasons for faults, environmental values, for example temperature or humidity, may also be taken into account in the type of control of the indication device. In addition, the external logic unit may also use, for example, direct inputs such as voice or voice commands or commands via text messages, etc. to control an appropriate indication.

The type and selection of the available signals can therefore be set up in a variable manner in the external logic unit, as can the circumstances or events which trigger a signal.

It is also advantageous if the interface unit for forwarding the information relating to the operating state to be indicated to the external logic unit and/or for receiving a control signal from the external logic unit is designed without a direct logical connection of an input line, which comes from the technical apparatus, to a control line for controlling the one or more indication or warning elements. In this case, a logical connection should be understood as meaning a digitally coded connection line or a digitally coded wireless connection channel, wherein there may be a power supply via the technical apparatus for operating the one or more indication or warning elements.

As a result, logical or digitally coded control of the one or more indication or warning elements is possible in a manner differing from the incoming signal from the technical apparatus.

In one particular embodiment of the invention, the interface unit for forwarding the information relating to the operating state to be indicated to the external logic unit and/or for receiving a control signal from the external logic unit is designed without the interposition of an internal logic unit. This ensures, on the one hand, that the external logic unit receives the information arriving from the technical apparatus without change, and, on the other hand, the indication or warning element(s) is/are controlled without the influence of such an internal logic unit.

In one development of this embodiment, no internal device at all for directly controlling the one or more indication or warning elements with the circumvention of the external logic unit is provided. It is therefore ensured that all indication or warning operations which are carried out by the operating state indication device and all signals arriving from the respective technical apparatus can be captured by the external logic unit.

However, in another embodiment, an additional, internal logic unit is provided in order to additionally offer the known functions according to the prior art.

In one preferred embodiment of a device according to the invention, the latter is in the form of a modular signal tower with exchangeable modules. A device according to the invention can therefore be easily configured with a wide variety of exchangeable modules.

In addition, it is possible to use conventional modular signal towers to implement a device according to the invention by incorporating a module which comprises the interface unit. In this case, only one module having an interface unit must therefore be additionally created in order to implement the invention.

Such a module may be in the form of a base module, via which the device is connected to the technical apparatus, the operating state of which is intended to be indicated or captured. The interface unit according to the invention is then accommodated in this base module.

In one advantageous embodiment, the interface unit is provided in an exchangeable module, thus further increasing the flexibility in terms of the configuration of the device according to the invention.

In order to improve data security, the interface unit is advantageously provided with an encryption unit in order to enable encrypted interchange of data with the external logic unit.

Furthermore, in one advantageous development of the invention, a control line for connecting the interface unit to the technical apparatus is provided and can be used to control the technical apparatus from the external logic unit. This control line can be wired or wireless. Cabling is possible without any problems in this case since such indication devices are usually cabled to the technical apparatus, the operating states of which are intended to be indicated. In the case of a wireless connection, a corresponding transmission and reception unit ought to be provided in the technical apparatus for this purpose.

The external logic unit is advantageously designed as part of a data processing system in order to implement the above-mentioned functions of considering further external information.

A wireless connection is preferably also provided between the interface unit and the external logic unit or the associated data processing system, thus enabling simple installation, in particular in connection with a plurality of inventive indication devices. The wireless connection may be in the form of a radio connection with different communication protocols, for example with the aid of conventional standardized types of connection and/or connection frequencies, for example: GSM, GPRS, Edge, 3G, 5G, LTE, LTE Narrow Band, LTE-M1, 169 MHz, 868 MHz, 2.4 GHz, 5 GHz, Bluetooth, Wi-Fi, NFC, RFID, Thread, 6Low PAN, ZigBee, IEEE802.15.4, MAC, proprietary, etc.

In addition to electromagnetic information transmission, for example the cited radio connections, or signal transmission with visible light, the wireless connection could also be effected on the basis of ultrasound. Ultrasound transmission provides advantages, in particular at close range or in an environment in which strong electromagnetic interference can be expected.

As already stated above, it is advantageous if a plurality of operating state indication devices are connected to the same external logic unit. In particular, it is therefore also possible to set up a network in which, in one particular embodiment, an indirect connection of an indication device according to the invention to the external logic unit is also enabled by bypassing interposed indication devices.

In one particular embodiment, the data processing system comprises a storage and/or evaluation unit for storing and/or evaluating the incoming information relating to the operating states and/or the transmitted control signals for indication. Comprehensive evaluation of the captured operating states, in particular over longer periods and with the consideration of additional external information, as stated above, is possible with the aid of the data processing. This evaluation may comprise a comprehensive database and its evaluation, wherein all possibilities which arise at present or in the future can be used to obtain information. This information can be used to control production, to maintain the machine functions, for prediction or probability statements through to obtaining logistical information, controlling information or other commercial needs.

The information obtained can be directly linked to corresponding control reactions for operating the technical apparatus(es) or corresponding indications. The evaluation unit may parameterize switching signals in order to control the indication device and/or the technical apparatus.

For example, in addition to one or more operating states, notifications can be generated via the indication or warning elements in order to indicate predicted events in the production sequence. For example, the need for partial replenishment which is required straightaway, the removal of full magazines or the like can be indicated in good time by means of the indication device. It is also possible to indicate product properties which depend on external parameters, for example sensor data, etc., which are taken into account via the evaluation unit. For example, an operator can be advised of a necessary check of machine setting, parts quality or the like via the indication device.

The variable generation of voice outputs for instructing or warning persons, in particular using voice synthesis for acoustic indication or warning elements, is also conceivable.

These applications show, for example, how the indication and warning function can be considerably expanded by the external control of the indication and warning elements.

In this case, the use of different algorithms through to the use of artificial intelligence, neural networks, a cognitive service, a cloud service, an IoT (Internet of Things) platform or the like is conceivable.

An indication apparatus according to the invention is therefore a source for capturing operating data and is simultaneously used as an indication and/or control unit for a multiplicity of measures which result from the evaluation or are generated in the evaluation unit, wherein further data, for example from the environment, further databases, etc., or predefined rules can also be included in the evaluation, in particular.

The evaluation unit may additionally also manage other apparatuses and may use the data obtained by means of the indication device according to the invention for this purpose.

One exemplary embodiment of the invention is illustrated in drawings and is explained in more detail below on the basis of the figures.

In Detail:

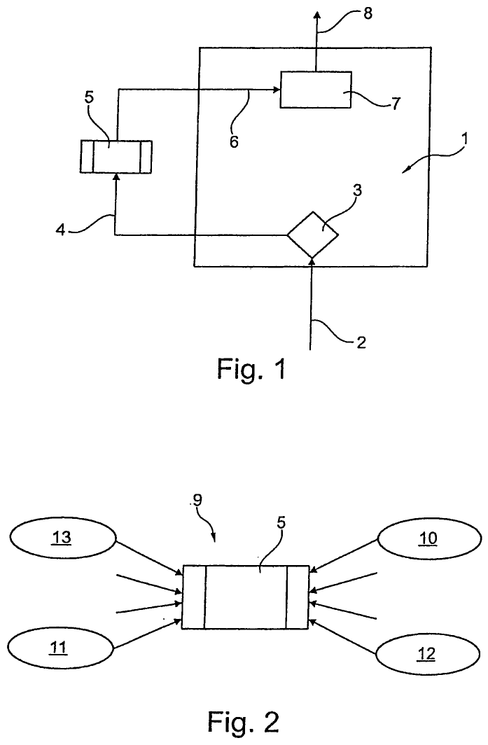

FIG. 1 shows a block diagram for illustrating the structure of a base and/or exchangeable module with an interface according to the invention,

FIG. 2 shows a block diagram for illustrating the function of an external control unit according to the invention,

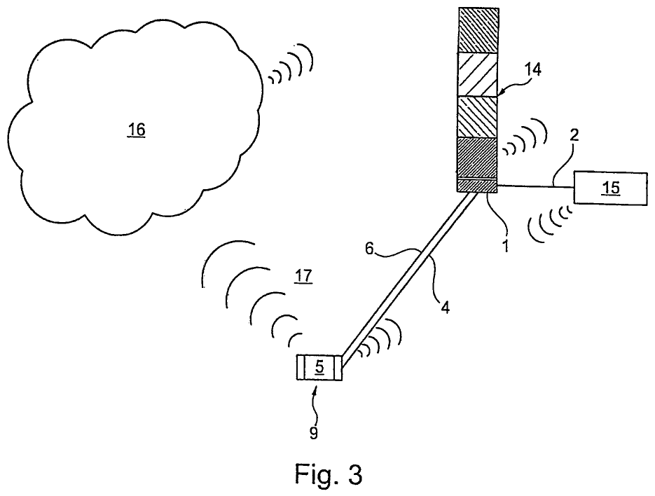

FIG. 3 shows a block diagram for illustrating the external control of a signal tower, and

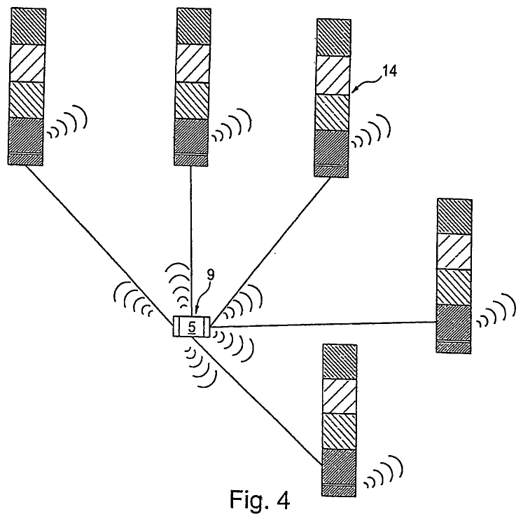

FIG. 4 shows a block diagram for illustrating a network comprising different signal towers with an external logic unit.

FIG. 1 illustrates an interface module 1 of an indication device according to the invention, in particular a signal tower. An input line 2 comes from a technical apparatus, the operating state of which is to be indicated, for example a machine or the like.

A forwarding unit, in particular in the form of a wireless transmission unit 3, is used to forward one or more signals, for example from a machine, to an external logic unit 5 via a connection channel 4 which is preferably wireless.

The external logic unit is connected, via a control channel 6 which is in turn preferably wireless, to a reception unit 7 of the interface unit 1, from which one or more control lines 8 lead to the individual indication or warning elements which are not illustrated, for example in the form of preferably differently colored lighting elements, or to acoustic elements.

FIG. 2 shows an embodiment in which the logic unit 5 is part of an evaluation unit 9 of a data processing system which, in addition to the data provided by the interface unit, can use further different input data for evaluation and control. For example, customer data 10, for example relating to delivery times, delivery scopes etc., predefined signal states 11, for example for indicating external states, events or the like, such as an expected delivery bottleneck, a last-minute order changeover etc., location data 12 relating to persons and/or machines and order data 13 are illustrated.

FIG. 3 illustrates a signal tower 14 as an example of an indication device according to the invention and a machine 15 as an example of a technical apparatus, the operating state(s) of which is/are to be indicated. There is also a cloud 16 which is connected to the evaluation unit 9 or to its logic unit 5, preferably via a wireless connection channel 17, for the purpose of transmitting data and/or programs. All connections are also illustrated as wireless connections. In addition to the interface connection beyond the interface module 1 illustrated as a base module, the machine 15 can also be directly connected to the cloud in order to transmit machine data which can be used when controlling the signal tower 14.

The illustration according to FIG. 4 illustrates a network comprising different signal towers 14 which are connected to an external logic unit 5 or evaluation unit 9. This embodiment has a star-shaped structure. However, other network configurations are conceivable, in particular also using a plurality of logic units 5 or evaluation units 9.

However, the illustrated embodiment having a logic unit 5 and an evaluation unit 9 provides the advantage that all data and control operations can be centrally captured and therefore can also be centrally processed, with the result that complete data capture, for example for creating a database, can be easily implemented.

### LIST OF REFERENCE SIGNS

1. Interface unit
2. Input line
3. Transmission unit
4. Connection channel
5. External logic unit
6. Control channel
7. Reception unit
8. Control line
9. Evaluation unit
10. Customer data
11. Signal states
12. Location data
13. Order data
14. Signal tower
15. Machine
16. Cloud
17. Connection channel

1. Operating state indication device (1) for optically and/or acoustically indicating at least one operating state or a plurality of different operating states of a technical apparatus, such as a machine, an installation, a vehicle or the like, having at least one optical and/or acoustic indication and/or warning element (2), wherein setting and/or adjustment of at least one operating parameter of the indication and/or warning element, such as luminous color, color intensity, luminous image, volume, melody, tone sequence or the like, is provided, wherein at least one input line (2), which comes from the technical apparatus and is intended to transmit the information relating to at least one operating state, and at least one control line (8) to the indication and/or warning element for controlling the indication of the operating state are provided, characterized in that an interface unit for forwarding the information relating to the operating state, which arrives from the technical apparatus, to an external logic unit (5) and/or for receiving a control signal from the external logic unit (5) for directly controlling one or more indication or warning elements is provided.

2. Device according to claim 1, characterized in that the interface unit for forwarding the information relating to the operating state, which arrives from the technical apparatus, to an external logic unit (5) and/or for receiving a control signal from the external logic unit (5) for directly controlling one or more indication or warning elements is provided without the interposition of an internal logic unit and/or without a direct logical connection of the input line (2) to the control line (8).

3. The device according to claim 1, characterized in that no internal logic unit for directly controlling the one or more indication or warning elements with the circumvention of the external logic unit (5) is provided.

4. The device according to claim 1 further comprising an additional, internal logic unit for directly controlling the one or more indication or warning elements with the circumvention of the external logic unit.

5. The device according to claim 2 wherein the device is a modular signal tower with exchangeable modules.

6. The device according to claim 2 further comprising a base module via which the device can be connected to the technical apparatus and which comprises the interface unit.

7. The device according to claim 2 further comprising an exchangeable module which comprises interface unit.

8. The device according to claim 7 wherein the interface unit comprises an encryption unit for the encrypted interchange of data with the external logic unit (5).

9. The device according to claim 2 wherein the control line (8) for connecting the interface unit to the technical apparatus is provided and can be used to control the technical apparatus via the interface unit.

10. A data processing system having an operating state indication device (1) and a logic unit (5) which is external with respect to this operating state indication device (1), characterized in that at least one wireless connection is provided between the interface unit and the external logic unit (5).

11. The data processing system according to claim 10 wherein the at least one wireless connection has an electromagnetic information transmission.

12. The data processing system of claim 10 wherein the wireless connection comprises information transmission based on ultrasound.

13. The data processing system of claim 10 wherein a plurality of operating state indication devices (14) are connected to the same external logic unit (5).

14. The data processing system of claim 10 further comprising an evaluation unit (9) for storing and/or evaluating the incoming information relating to the operating state or the operating states and/or the transmitted control signals for indication.

15. The data processing system of claim 10 further comprising an installed AI (artificial intelligence, machine learning or data analytics).

16. The data processing system according to claim 10 having a prediction program for predicting imminent faults, imminent material shortages, planned or preventative maintenance, pending personnel changes, order changes, performance problems, deviations from actual values to desired values.

17. The data processing system according to claim 10 wherein the external logic unit (5) has a data acquisition unit for capturing or receiving parameter data for parameters, such as sensor information, environmental information, order information, stocks or the like, which can be used to control the interface unit.

18. The data processing system of claim 10 wherein a plurality of wireless connections are connected to a plurality of devices.

19. An apparatus for optically and/or acoustically indicating one operating state from a plurality of operating states of a first device comprising:
(a) a modular signal tower with interchangeable modules having a variable indication of the variable function of a variable function of the first device;
(b) an external logic unit to analyze and receive and transmit data to and from the first device as well as further external data that does not directly come from the first device;
(c) an interface unit to interface with the first device; and
(d) a data link from the external logic unit to the modular signal tower.

20. The apparatus of claim 19 wherein the interface unit is an exchangeable module.
